(19) United States
(12) Patent Application Publication
(10) Pub. No.: US 2011/0189970 A1
(43) Pub. Date: Aug. 4, 2011

(54) Receiving apparatus and image rejection method

(75) Inventor: Masayoshi Ohshiro, Kanagawa (JP)

(73) Assignee: Renesas Electronics Corporation, Kawasaki (JP)

(21) Appl. No.: 12/929,529

(22) Filed: Jan. 31, 2011

(30) Foreign Application Priority Data
Feb. 1, 2010 (JP) 2010-020453

(51) Int. Cl. H04B 1/10

(52) U.S. Cl. 455/302

(57) ABSTRACT

An orthogonal mixer generates first I and Q signals by down-converting an RF signal. A complex filter has an asymmetrical frequency gain property between a positive frequency domain and a negative frequency domain, and generates second I and Q signals by suppressing image signals included in the first I and Q signals compared with desired signals. An orthogonal compensation circuit is located at a subsequent stage of the complex filter, and corrects the second I and Q signals to cancel a phase difference error and an amplitude error of the desired signals between the second I and Q signals. Further, a control circuit adjusts an element characteristic of the complex filter to cancel a phase difference error and an amplitude error of the image signals that appear in the second I and Q signals.

### INCORPORATION BY REFERENCE

This application is based upon and claims the benefit of priority from Japanese patent application No. 2010-020453, filed on Feb. 1, 2010, the disclosure of which is incorporated herein in its entirety by reference.

### BACKGROUND

1. Field of the Invention

The present invention relates to an image rejection in a superheterodyne receiver.

2. Description of Related Art

The Hartley architecture and the Weaver architecture are known as image rejection schemes in a superheterodyne receiver. The Hartley architecture and the Weaver architecture are image rejection schemes using the fact that a desired signal and an image signal are located opposite to each other with respect to a local frequency. The Hartley architecture and the Weaver architecture execute a phase shift operation on an Intermediate Frequency (IF) signal after being orthogonal down-converted, thereby providing different phase shifts to the desired signal and the image signal. Accordingly, the desired signal and the image signal can be distinguished on the frequency axis.

More specifically, the Hartley architecture shifts a phase by 90 degrees by a phase shift circuit so that desired signals have the same signs and image signals have different signs between an in-phase signal (I signal) path and an orthogonal signal (Q signal) path in a subsequent stage of the orthogonal down-conversion. By adding the I signal and the Q signal after 90-degree phase shift operation, the image signals are removed.

The Weaver architecture uses an orthogonal mixer instead of using the phase shift circuit used in the Hartley architecture. More specifically, the Weaver architecture executes a first down conversion with the first-stage orthogonal mixer on RF signal, and a second down-conversion with the second-stage orthogonal mixer on the IF signal obtained by the first down-conversion. By subtracting the I path signal and the Q path signal after the second down-conversion, an image signal in the desired bandwidth (typically around DC (0 Hz)) is cancelled. Thus, the image signals are suppressed, thereby making it possible to obtain only the desired signal.

Further, such a method is also known as using a complex filter to remove an image signal in the superheterodyne receiver. For example, in order to reject an image signal in low side injection, a complex filter (complex band-pass filter) having asymmetrical transfer characteristic is used in which a gain of a negative frequency domain is relatively smaller than a gain of a positive frequency domain. Hence, an image signal can be selectively attenuated. The configuration of the complex filter includes a passive type and an active type. A polyphase filter including resistors and capacitors is known as the passive complex filter. A Gm-C filter including transconductance elements and capacitors is known as the active complex filter. Further, a configuration of feedback-connecting between two real low-pass filters, each of which formed of operational amplifiers, resistors, and capacitors, is known as another configuration of the active complex filter.

The complex filter for image rejection performs processing on four signals including an I signal and a Q signal after being orthogonal down-converted and inverting signals thereof having phase difference of 90 degrees with each other. However, when there is an amplitude difference between IQ signals after being orthogonal down-converted, or when the phase difference between IQ signals is deviated from 90 degrees, the image rejection ratio (image suppression ratio) is degraded. The amplitude error and the phase difference error between IQ signals are called “IQ mismatch”. Differences of element characteristics between the I signal path and the Q signal path of a complex filter, an orthogonal mixer, and an oscillation circuit generating a local signal causes IQ mismatch.

Japanese Unexamined Patent Application Publication No. 2006-157866 (JP 2006-157866 A) discloses a method for reducing the IQ mismatch when the image rejection is performed using a Gm-C filter. JP 2006-157866 A specifically discloses inputting a pseudo image signal to a Gm-C filter and adjusting an element in the Gm-C filter so as to decrease the amplitude of the pseudo image signal that appears in the output of the Gm-C filter. Further, JP 2006-157866 A discloses arranging a variable phase shifter (phase adjustment circuit) at a former stage of the Gm-C filter, and adjusting a phase difference of IQ signals input to the Gm-C filter by the phase adjustment circuit so as to decrease the amplitude of the pseudo image signal that appears in the output of the Gm-C filter.

Further, Japanese Unexamined Patent Application Publication No. 2001-45080 (JP 2001-45080 A) discloses a receiver including a variable phase shifter provided at a former stage of a polyphase filter that is capable of adjusting amplitude. The receiver disclosed in JP 2001-45080 A adjusts the variable phase shifter by monitoring the phase difference between IQ signals input to the polyphase filter, thereby controlling the phase difference between IQ signals input to the polyphase filter to be 90 degrees. Further, the receiver disclosed in JP 2001-45080 A adjusts a variable resistor or a variable capacitor forming the polyphase filter so as to make the electric power of an image signal that emerges in the output of the polyphase filter minimum.

### SUMMARY

The present inventor has examined if it is possible to improve the image rejection ratio in the whole receiver by using a complex filter and an image rejection configuration such as the Hartley architecture and the Weaver architecture. As a result, the present inventor has found that special consideration needs to be given to correct the IQ mismatch of both of the desired signal and the image signal, in other words, to maintain the orthogonality of both of the desired signal and the image signal when the two image rejection technologies of the complex filter and the image rejection configuration such as the Weaver architecture or the Hartley architecture are combined.

For example, when the image rejection by the Hartley architecture or the Weaver architecture is performed, one possible measure is to perform IQ mismatch correction on the desired signal and the image signal in the subsequent stage of the first down-conversion. However, when the complex filter is further used, it is difficult to ensure the orthogonality of both of the desired signal and the image signal with this method. This is because there is a difference between the degrees of the IQ mismatch (i.e. amplitude shift and phase shift) of the desired signal and the image signal generated in the complex filter.

Only adjustments of the element in the complex filter and the variable phase shifter so as to decrease the amplitude and the power of the image signal in the output of the complex filter signal as disclosed in JP 2006-157866 A and JP 2001-45080 A do not lead to the sufficient correction of the IQ mismatch of the desired signals.

A first exemplary aspect of an embodiment of the present invention includes a receiving apparatus including an orthogonal mixer, a complex filter, an orthogonal compensation circuit, and a controller. The orthogonal mixer is configured to down-convert a radio signal, and to generate a first in-phase signal and a first orthogonal signal. The complex filter has an asymmetrical frequency gain property between a positive frequency domain and a negative frequency domain, and is configured to generate a second in-phase signal and a second orthogonal signal by suppressing image signals included in the first orthogonal signal and the first in-phase signal compared with desired signals. The orthogonal compensation circuit is located at a subsequent stage of the complex filter, and is configured to correct the second in-phase signal and the second orthogonal signal so as to cancel a phase difference error and an amplitude error of the desired signals between the second in-phase signal and the second orthogonal signal. The controller adjusts an element characteristic of an element included in the complex filter so as to cancel a phase difference error and an amplitude error of the image signals between the second in-phase signal and the second orthogonal signal.

As described above, by using the complex filter, there is produced a difference between the IQ mismatch of the desired signal and the IQ mismatch of the image signal. More specifically, the IQ mismatch of the image signal is greatly increased compared with the IQ mismatch of the desired signal. The first exemplary aspect of the present invention addresses with this problem by adjusting the element characteristic of the element included in the complex filter, thereby compensating the IQ mismatch of the image signal. Further, the IQ mismatch of the desired signal is compensated using an orthogonal compensation circuit arranged at a subsequent stage of the complex filter. In summary, the first exemplary aspect of the present invention performs the IQ mismatch compensation for the image signal, which is difficult to address only in the subsequent stage side of the complex filter, by element adjustment in the complex filter, and performs the IQ mismatch compensation for the desired signal in the subsequent stage of the complex filter. Accordingly, both of the IQ mismatch of the desired signal and the IQ mismatch of the image signal having different magnitude with each other can be compensated.

The first exemplary aspect of the present invention described above makes it possible to maintain the orthogonality of both of the desired signal and the image signal when the complex filter and the image rejection configuration such as the Weaver architecture or the Hartley architecture are combined.

### BRIEF DESCRIPTION OF THE DRAWINGS

FIG. 1 is a diagram showing a configuration example of an image rejection receiver according to an exemplary embodiment of the present invention;

FIG. 2 is a diagram showing one example of a transfer function of a complex filter;

FIG. 3 is a diagram showing a configuration example of the complex filter;

FIG. 4 is a flow chart showing one example of an adjustment procedure regarding IQ mismatch compensation in both of image signal and desired signal in the image rejection receiver shown in FIG. 1;

FIG. 5 is a graph showing a phase difference error and an amplitude error before compensating IQ mismatch;

FIG. 6 is a graph showing a phase difference error and an amplitude error after performing phase adjustment regarding an image signal, starting from the state shown in FIG. 5;

FIG. 7 is a graph showing a phase difference error and an amplitude error after performing amplitude adjustment regarding an image signal, starting from the state shown in FIG. 6; and

FIG. 8 is a diagram showing another configuration example of the image rejection receiver shown in FIG. 1.

### DETAILED DESCRIPTION OF THE EXEMPLARY EMBODIMENTS

Hereinafter, specific exemplary embodiments of the present invention will be described in detail with reference to the drawings. Throughout the drawings, the same components are denoted by the same reference symbols, and overlapping description will be omitted as appropriate for the sake of clarification of description.

### First Exemplary Embodiment

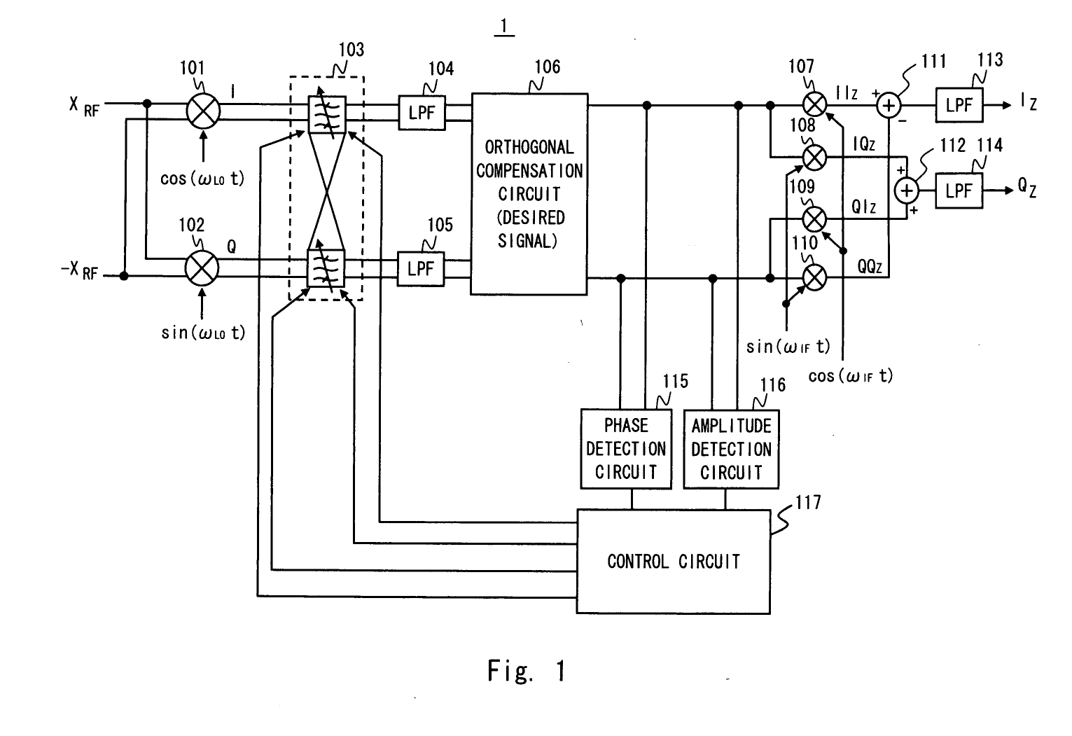

FIG. 1 is a block diagram showing a configuration example of an image rejection receiver 1 according to a first exemplary embodiment of the present invention. The receiver 1 shown in FIG. 1 performs image suppression by a complex filter and image rejection by the Weaver architecture by combining them. More specifically, a complex filter 103 is arranged between a first orthogonal mixer (mixers 101 and 102) and a second orthogonal mixer (mixers 107 and 110, and mixers 108 and 109).

The mixer 101 shown in FIG. 1 multiplies differential RF signals (X_{RF} and −X_{RF}) by a local signal (cos(ω_{LO}t)), so as to generate an in-phase signal (I signal) of IF bandwidth. The mixer 102 multiplies differential RF signals (X_{RF} and −X_{RF}) by a local signal (sin(ω_{LO}t)), so as to generate an orthogonal signal (Q signal) of IF bandwidth.

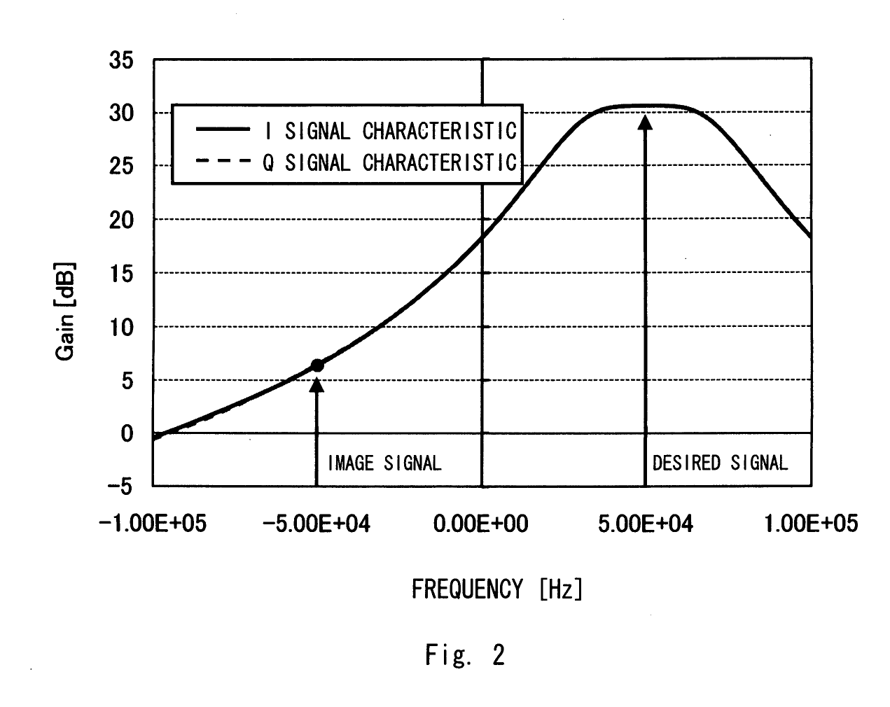

The complex filter 103 has an asymmetrical frequency gain property between a positive frequency domain and a negative frequency domain. The complex filter 103 receives the I signal and the Q signal generated by the mixers 101 and 102, and suppresses image signals included in the I and Q signals compared with desired signals included in the I and Q signals. FIG. 2 is a graph showing a specific example of gain frequency properties of the complex filter 103. Although FIG. 2 shows two graphs of a characteristic graph with respect to the I signal (solid line in FIG. 2) and a characteristic graph with respect to the Q signal (dashed line in FIG. 2), these two graphs are substantially overlapped with each other in FIG. 2. In the low side injection, as shown in FIG. 2, the desired signal is located in the positive frequency domain, and the image signal is located in the negative frequency domain. Since the negative frequency domain has lower gain compared with the positive frequency domain in the gain frequency properties shown in FIG. 2, the electric power of the image signal after passing through the complex filter 103 is suppressed compared with the electric power of the desired signal.

Further, the complex filter 103 is configured to be able to adjust the element characteristic therein. The complex filter 103 is able to control the phase and the amplitude of the image signals included in the I signal and the Q signal after passing through the filter 103 by adjusting the element characteristic. The configuration example and specific example of a procedure for adjusting the element characteristic of the complex filter 103 will be described later in detail.

Low-pass filters (LPFs) 104 and 105 attenuate the high-frequency components included in the I signal and the Q signal after the down-conversion performed by the mixers 101 and 102.

An orthogonal compensation circuit 106 performs signal processing on desired signals included in the I signal and the Q signal after passing through the LPFs 104 and 105. More specifically, the orthogonal compensation circuit 106 corrects the I signal and the Q signal so as to make the phase difference between the desired signal included in the I signal and the desired signal included in the Q signal approach 90 degrees and to eliminate the amplitude difference of the desired signals.

The mixers 107 to 110 correspond to the latter-stage mixers of the Weaver architecture. The mixer 107 mixes the I signal after passing through the orthogonal compensation circuit 106 with a local signal (cos(ω_{IF}t)), so as to generate an IIz signal which is down-converted to around DC (0 Hz). The mixer 108 mixes the I signal after passing through the orthogonal compensation circuit 106 with a local signal (sin(ω_{IF}t)), so as to generate an IQz signal which is down-converted to around DC (0 Hz). The mixer 109 mixes the Q signal after passing through the orthogonal compensation circuit 106 with the local signal (cos(ω_{IF}t)), so as to generate a QIz signal which is down-converted to around DC (0 Hz). The mixer 110 mixes the Q signal after passing through the orthogonal compensation circuit 106 with the local signal (sin(ω_{IF}t)), so as to generate a QQz signal which is down-converted to around DC (0 Hz).

An addition (subtraction) circuit 111 subtracts the QQz signal from the IIz signal, so as to generate an Iz signal in which the image signal is cancelled around DC where the desired signal is located. Further, an addition circuit 112 adds the IIz signal and the QQz signal, so as to generate a Qz signal in which the image signal is cancelled around DC where the desired signal is located. LPFs 113 and 114 remove the image signal components located in the high frequency domain (ωRF−ωLO+ωIF) of the Iz signal and the Qz signal, and transmit the desired signal components located around DC.

A phase detection circuit 115 detects the phases of the image signals included in the I signal and the Q signal or the phase difference between them between the complex filter 103 and the second-stage mixers 107 to 110 of the Weaver architecture. The phase detection circuit 115 is able to detect the phase difference between IQ signals by integrating the multiplication result of the I signal and the Q signal. In this case, the phase detection circuit 115 may include a multiplication circuit and an integration circuit.

An amplitude detection circuit 116 detects the amplitude of the image signals included in the I signal and the Q signal or the amplitude difference between them.

A control circuit 117 refers to the detection result of the phase or the phase difference detected by the detection circuit 115, and the detection result of the amplitude or the amplitude difference detected by the detection circuit 116, so as to adjust the element characteristic in the complex filter 103 so, as to make the phase difference between the image signals included in the IQ signals close to 90 degrees and to eliminate the amplitude difference. More specifically, the control circuit 117 is able to adjust the phase difference between the image signals included in the IQ signals by changing the resistance value of at least one variable resistance element arranged in the complex filter 103. Further, the control circuit 117 is able to adjust the amplitude difference between the image signals included in the IQ signals by changing the capacitance value of at least one variable capacitance element arranged in the complex filter 103.

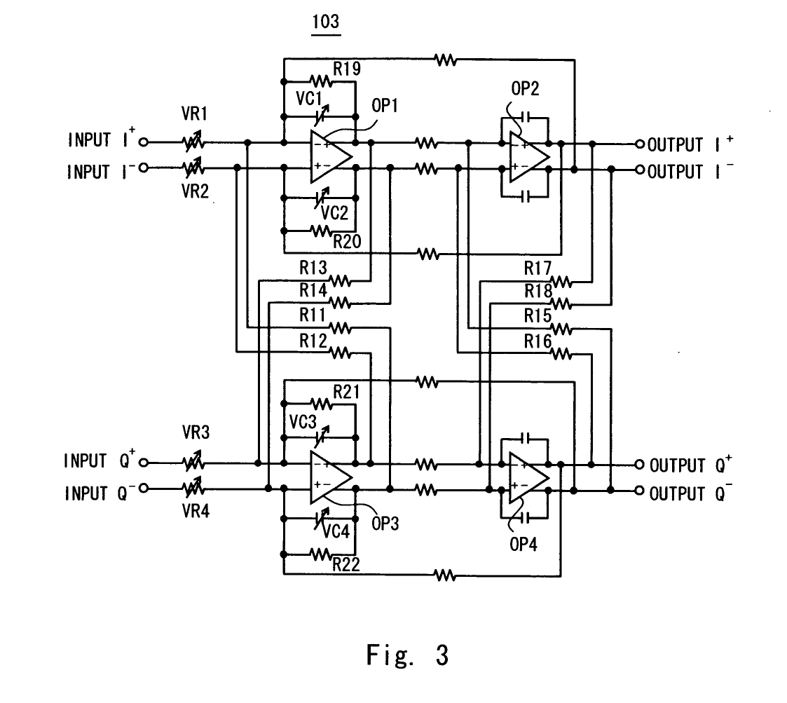

FIG. 3 is a circuit diagram showing a configuration example of the complex filter 103. The complex filter 103 shown in FIG. 3 has a configuration in which two real low-pass filters are feedback-connected, each of which including operational amplifiers, resistors, and capacitors. Each of the operational amplifiers OP1 to OP4 operates as a low-pass filter (integration circuit). Further, a non-inverting output terminal and an inverting output terminal of the operational amplifier OP1 are connected to an inverting input terminal and a non-inverting input terminal of the operational amplifier OP2 through resistors, respectively. Accordingly, a combination of the operational amplifiers OP1 and OP2 operates as an actual low-pass filter. Further, a non-inverting output terminal and an inverting output terminal of the operational amplifier OP3 are connected to an inverting input terminal and a non-inverting input terminal of the operational amplifier OP4 through resistors, respectively. Accordingly, a combination of the operational amplifiers OP3 and OP4 operates as an actual low-pass filter.

Further, the output terminals of the operational amplifier OP1 are feedback-connected to the input terminals of the operational amplifier OP3 and the output terminals of the operational amplifier OP3 are feedback-connected to the input terminals of the operational amplifier OP1, respectively through resistors R11 to R14. In the similar way, the input and the output terminals of the operational amplifier OP2 are connected to the output and the input terminals of the operational amplifier OP4, respectively, through resistors R15 to R18. Accordingly, the filter circuit shown in FIG. 3 serves as the complex band-pass filter having asymmetrical gain frequency property in the positive frequency domain and the negative frequency domain. Now, the feedback-connections will be described further in detail. The inverting output terminal (−) of the OP1 is feedback-connected to the non-inverting input terminal (+) of the OP3, the non-inverting output terminal (+) of the OP1 is feedback-connected to the inverting input terminal (−) of the OP3, the inverting output terminal (−) of the OP3 is feedback-connected to the inverting input terminal (−) of the OP1, and the non-inverting output terminal (+) of the OP3 is feedback-connected to the non-inverting input terminal (+) of the OP1. The feedback-connections between the operational amplifiers OP2 and OP4 is similar to the one stated above.

The filter circuit shown in FIG. 3 includes variable resistance elements VR1 to VR4 arranged at the previous stages of the operational amplifiers OP1 and OP3. The variable resistance elements VR1 to VR4 are configured so that the resistance values in the variable resistance elements VR1 to VR4 can be changed by the external control circuit 117. Further, the filter circuit shown in FIG. 3 includes variable capacitance elements VC1 to VC4 functioning as two capacitance elements connecting the input's and the outputs of the operational amplifier OP1 and two capacitance elements connecting the inputs and the outputs of the operational amplifier OP2. The variable capacitance elements VC1 to VC4 are configured so that the capacitance values in the variable capacitance elements VC1 to VC4 can be changed by the external control circuit 117. The control circuit 117 may adjust the phase difference of the image signals between IQ signals by changing the resistance values of the variable resistance elements VR1 to VR4. Further, the control circuit 117 may adjust the amplitude difference of the image signals between IQ signals by changing the capacitance values of the variable capacitance elements VC1 to VC4.

Although the variable resistance elements VR1 to VR4 are arranged at the previous stages of the operational amplifiers OP1 and OP3 in the configuration example shown in FIG. 3, resistors R19 to R22 shown in FIG. 3 may be variable resistors instead. The resistor R19 is connected between the inverting input terminal and the non-inverting output terminal of the operational amplifier OP1. The resistor R20 is connected between the non-inverting input terminal and the inverting output terminal of the operational amplifier OP1. The resistor R21 is connected between the inverting input terminal and the non-inverting output terminal of the operational amplifier OP3. The resistor R22 is connected between the non-inverting input terminal and the inverting output terminal of the operational amplifier OP3.

In the following description, an example of a procedure for adjusting the complex filter 103 and the orthogonal compensation circuit 106 to correct the IQ mismatch of both of the desired signal and the image signal will be described.

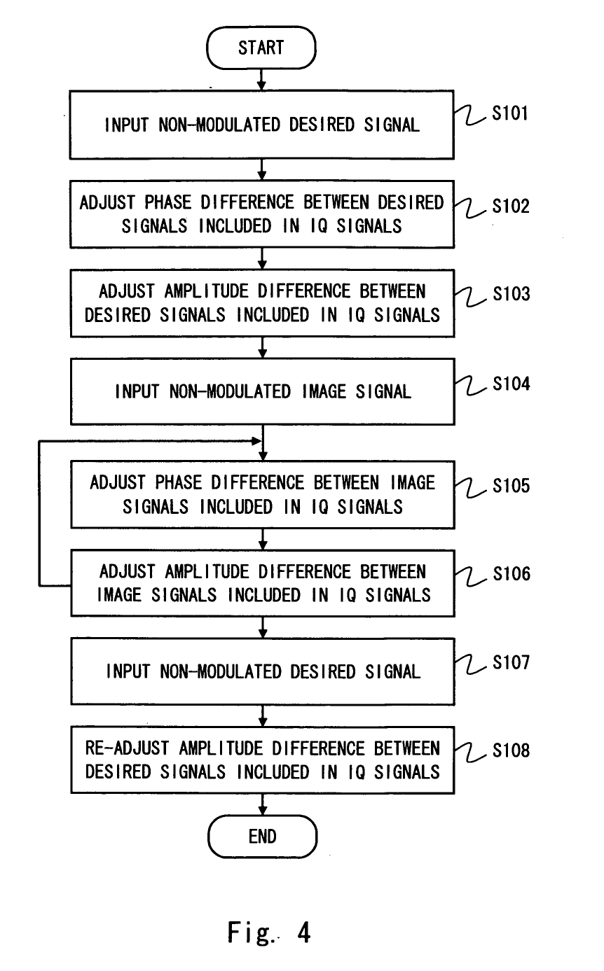

FIG. 4 is a flow chart showing one example of the adjustment procedure. In the example shown in FIG. 4, the phase difference between the desired signals included in the IQ signals and the amplitude difference between the desired signals included in the IQ signals are adjusted first (S101 to S103). Then, the phase difference between the image signals included in the IQ signals and the amplitude difference between the image signals included in the IQ signals are adjusted next (S104 to S106). Last, the amplitude difference between the desired signals included in the IQ signals is re-adjusted (S107 to S108).

In step S101, a non-modulated desired signal as pseudo desired signal is input to the receiver 1. In step S102, the orthogonal compensation circuit 106 adjusts the phase difference between the desired signals included in the IQ signals. In step S103, the orthogonal compensation circuit 106 adjusts the amplitude difference between the desired signals included in the IQ signals.

Subsequently, in step S104, a non-modulated image signal as pseudo image signal is input to the receiver 1. In step S105, the control circuit 117 adjusts the phase difference between the image signals included in the IQ signals by adjusting a capacitance value of the variable capacitance element in the complex filter 103. In step S106, the control circuit 117 adjusts the amplitude difference between the image signals included in the IQ signals by adjusting a resistance value of the variable resistance element in the complex filter 103. In steps S105 and S 106, the adjustment may be repeated until when the phase difference and the amplitude difference between the image signals included in the IQ signals are converged.

In order to correct the IQ amplitude error of the desired signals due to the adjustments of the phase difference and the amplitude difference between the image signals included in the IQ signals, in steps S107 and S108, re-adjustment of the desired signals is performed. In step S107, non-modulated desired signals as pseudo desired signals are input to the receiver 1. In step S108, the orthogonal compensation circuit 106 re-adjusts the amplitude difference between the desired signals included in the IQ signals.

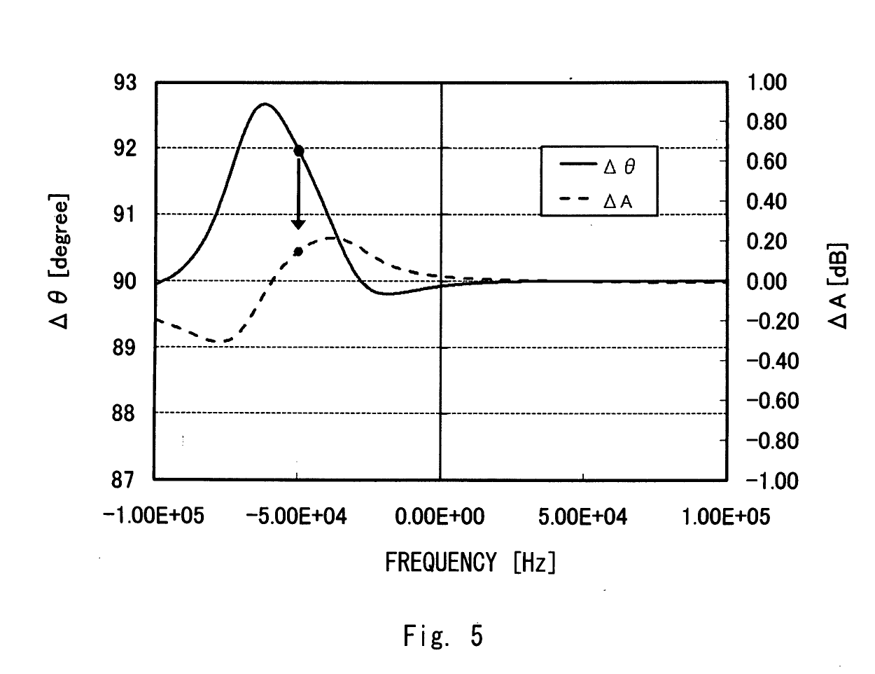

FIGS. 5 to 7 are graphs showing a phase difference (Δθ) and an amplitude difference (ΔA) between IQ signals in the adjustment process by the procedure shown in FIG. 4 obtained by performing computer simulation. FIGS. 5 to 7 correspond to FIG. 2 which is described above. In FIGS. 5 to 7, the desired signal is located around +50 kHz, and the image signal is located around −50 kHz.

FIG. 5 shows a phase difference Δθ and an amplitude difference ΔA after first-stage adjustments regarding the desired signal (steps S101 to S103) is completed. In step S105, as shown by a solid arrow in FIG. 5, the element characteristic in the complex filter is adjusted so that the phase difference Δθ in the frequency range where the image signal is located (around −50 kHz) approaches 90 degrees. For example, the resistance values of the variable resistance elements VR1 to VR4 shown in FIG. 3 may be adjusted.

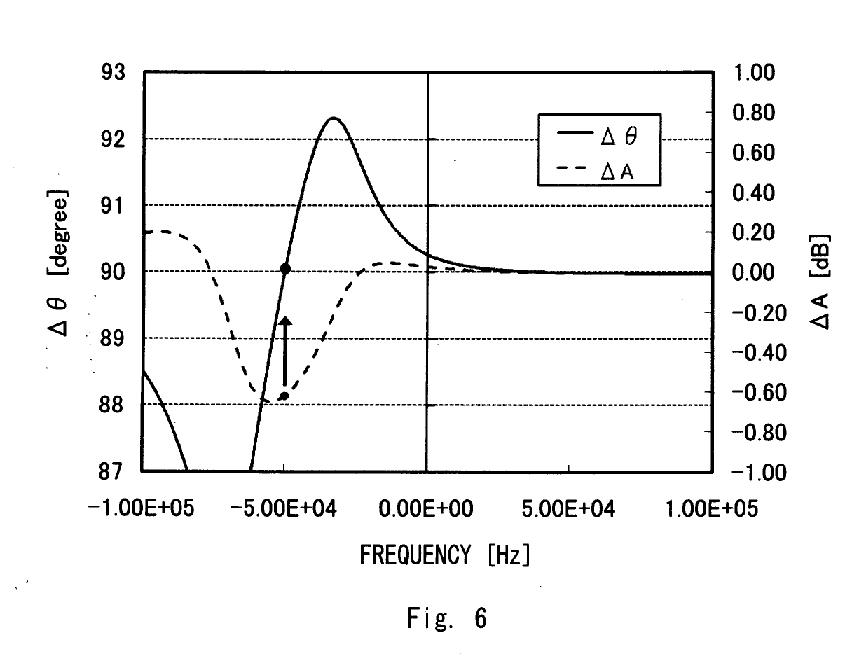

FIG. 6 shows AO and AA after the adjustment of the phase difference between the image signals included in the IQ signals (step S105) is completed. In step S106, as shown by a solid arrow in FIG. 6, the element characteristic in the complex filter is adjusted so that the amplitude difference ΔA in the frequency range where the image signal is located (around −50 kHz) approaches zero. For example, the capacitance values of the variable capacitance elements VC1 to VC4 shown in FIG. 3 may be adjusted.

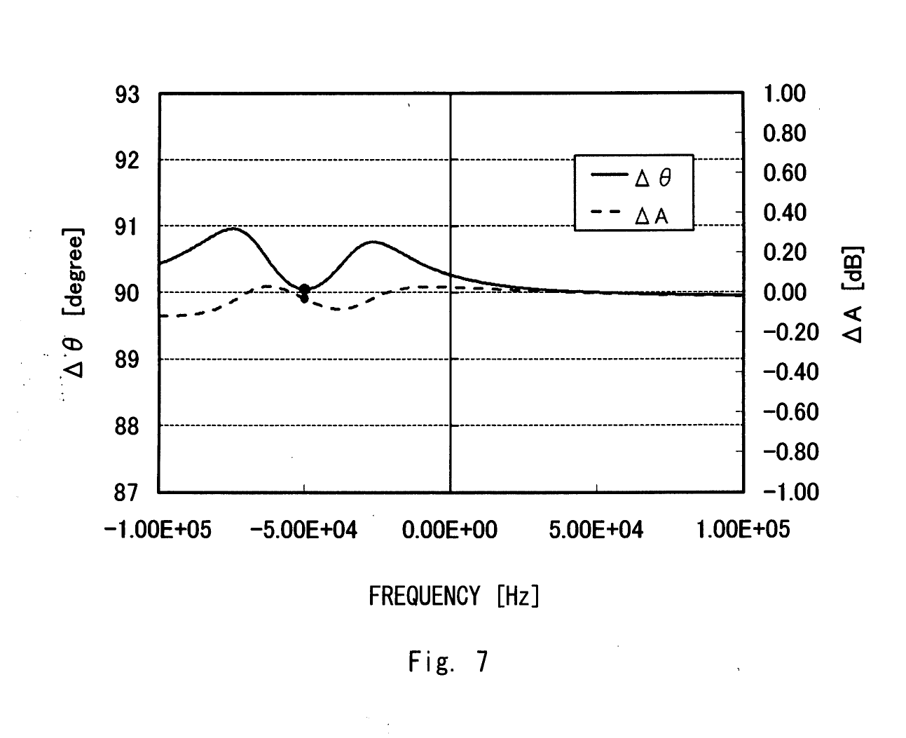

FIG. 7 shows Δθ and ΔA after the adjustment of the amplitude difference between the image signals included in the IQ signals (step S106) is completed. In step S108, preferably re-adjustment of the amplitude difference between the desired signals included in the IQ signals is performed.

According to the three-stage adjustment procedure in order of the desired signals, the image signals, and the desired signals as shown in FIG. 4, the adjustments of the complex filter 103 and the orthogonal compensation circuit 106 can be completed with few steps. However, the adjustment procedure shown in FIG. 4 is merely an example.

As described above, the receiver 1 according to the first exemplary embodiment performs the image rejection by combining the Weaver architecture and the complex filter 103. However, by arranging the complex filter 103, there is produced a difference between the IQ mismatch of the desired signal and the IQ mismatch of the image signal. More specifically, the IQ mismatch of the image signal is greatly increased compared with the IQ mismatch of the desired signal.

To address this problem, the receiver 1 adjusts the element characteristic of the element included in the complex filter 103, so as to compensate the IQ mismatch of the image signal. Further, the receiver 1 compensates the IQ mismatch of the desired signal by the orthogonal compensation circuit 106 arranged at a subsequent stage of the complex filter 103. In summary, the IQ mismatch compensation for the image signal that is difficult to address only in the subsequent stage side of the complex filter 103 is performed in the element adjustment in the complex filter 103, and the IQ mismatch compensation for the desired signal is performed in the subsequent stage of the complex filter 103. Accordingly, the receiver 1 is able to compensate both of the IQ mismatch of the desired signal and the IQ mismatch of the image signal, both IQ mismatches having different magnitude from each other. Accordingly, the receiver 1 is able to keep the orthogonality of both of the desired signal and the image signal, thereby improving the image rejection ratio.

### Other Exemplary Embodiment 1

Although the Weaver architecture and the complex filter have been combined in the first exemplary embodiment, the Hartley architecture may be used instead of using the Weaver architecture. In this case, the orthogonal mixing operation performed in the second-stage mixers 107 to 110 may be replaced with the 90-degree phase shift operation using the phase circuit.

### Other Exemplary Embodiment 2

The arrangement of the orthogonal compensation circuit 106 is not limited between the complex filter 103 and the second-stage mixers 107 to 110. For example, the orthogonal compensation circuit 106 may be arranged in the subsequent stage of the LPFs 113 and 114. When an analog modulation signal is received and the signal is down-converted by the second-stage mixers 107 to 110 to around DC, the orthogonal compensation circuit 106 is preferably arranged in the IF frequency section as shown in FIG. 1, whereby the phase rotation of the I signal and the Q signal can be observed and the phase difference deviation in the desired signals can be easily detected.

### Other Exemplary Embodiment 3

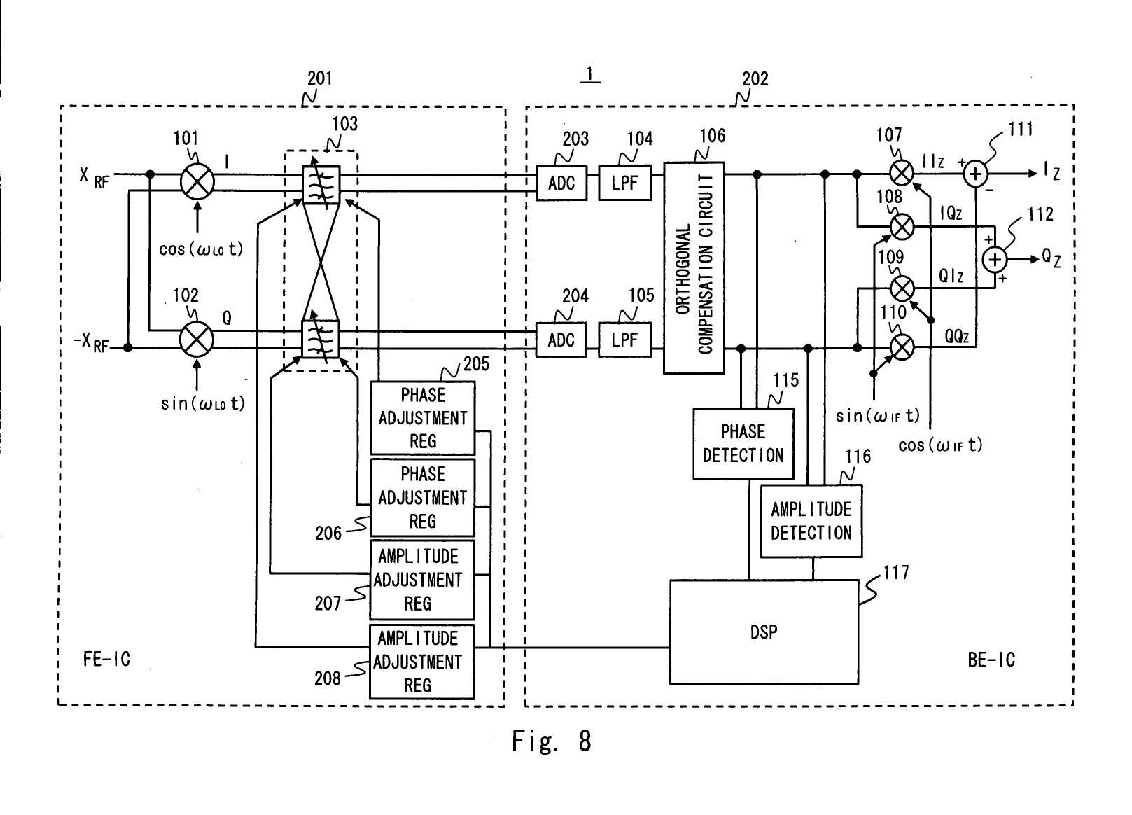

The complex filter 103 and the preceding circuits may be implemented by analog circuits, and LPFs 104 and 105 and the subsequent circuits may be implemented by digital circuits. FIG. 8 is a diagram showing a configuration example of the receiver 1 when the LPFs 104 and 105 and the subsequent circuits is implemented by digital circuits. A front-end IC (FE-IC) 201 shown in FIG. 8 includes mixers 101 and 102 and a complex filter 103, and performs analog signal processing. Note that resistors 205 to 208 hold set values for an element in the filter 103 to adjust the phase difference and the amplitude difference between IQ signals. The resistor 205 holds a set value for achieving the phase adjustment in the I side. The resistor 206 holds a set value for achieving the phase adjustment in the Q side. The resistor 207 holds a set value for achieving the amplitude adjustment in the I side. The resistor 208 holds a set value for achieving the amplitude adjustment in the Q side. The values held in the resistors 205 to 208 are rewritten by the control circuit 117.

A back-end IC (BE-IC) 202 shown in FIG. 8 includes circuits of the LPFs 103 and 104 and the subsequent circuits shown in FIG. 1, and performs digital signal processing on the I signal and the Q signal. As shown in FIG. 8, the control circuit 117 may be implemented using a DSP (Digital Signal Processor). Further, at least a part of other circuits included in the BE-IC 202 may be achieved using a computer system including an ASIC (Application Specific Integrated Circuit), a DSP, an MPU (Micro Processing Unit), a CPU (Central Processing Unit), or combinations thereof.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A receiving apparatus comprising:
an orthogonal mixer being configured to generate a first in-phase signal and a first orthogonal signal by down-converting a radio signal;
a complex filter having an asymmetrical frequency gain property between a positive frequency domain and a negative frequency domain, the complex filter being configured to generate a second in-phase signal and a second orthogonal signal by suppressing image signals included in the first orthogonal signal and the first in-phase signal compared with desired signals;
an orthogonal compensation circuit being located at a subsequent stage of the complex filter, the orthogonal compensation circuit being configured to correct the second in-phase signal and the second orthogonal signal so as to cancel a phase difference error and an amplitude error of the desired signals between the second in-phase signal and the second orthogonal signal; and
a controller being configured to adjust an element characteristic of an element included in the complex filter so as to cancel a phase difference error and an amplitude error of the image signals between the second in-phase signal and the second orthogonal signal.

2. The receiving apparatus according to claim 1, wherein the complex filter comprises at least one variable resistance element and at least one variable capacitance element that can be adjusted by the controller.

3. The receiving apparatus according to claim 2, wherein
the complex filter further comprises:
a first operational amplifier comprising a first inverting input terminal, a first non-inverting input terminal, a first inverting output terminal, and a first non-inverting output terminal; and
a second operational amplifier comprising a second inverting input terminal, a second non-inverting input terminal, a second inverting output terminal, and a second non-inverting output terminal.
the first inverting output terminal is feedback-connected to the second non-inverting input terminal, the first non-inverting output terminal is feedback-connected to the second inverting input terminal, the second inverting output terminal is feedback-connected to the first inverting input terminal, the second non-inverting output terminal is feedback-connected to the first non-inverting input terminal,
said at least one variable resistance element comprises first to fourth variable resistance elements,
said at least one variable capacitance element comprises first to fourth variable capacitance elements,
the first variable capacitance element is connected between the first inverting input terminal and the first non-inverting output terminal, the second variable capacitance element is connected between the first non-inverting input terminal and the first inverting output terminal,
the third variable capacitance element is connected between the second inverting input terminal and the second non-inverting output terminal,
the fourth variable capacitance element is connected between the second non-inverting input terminal and the second inverting output terminal, and
the first to fourth variable resistance elements are arranged at former stages of the first inverting input terminal, the first non-inverting input terminal, the second inverting input terminal, and the second non-inverting input terminal, respectively.

4. The receiving apparatus according to claim 2, wherein
the complex filter further comprises:
a first operational amplifier comprising a first inverting input terminal, a first non-inverting input terminal, a first inverting output terminal, and a first non-inverting output terminal; and
a second operational amplifier comprising a second inverting input terminal, a second non-inverting input terminal, a second inverting output terminal, and a second non-inverting output terminal,
the first inverting output terminal is feedback-connected to the second non-inverting input terminal, the first non-inverting output terminal is feedback-connected to the second inverting input terminal, the second inverting output terminal is feedback-connected to the first inverting input terminal, and the second non-inverting output terminal is feedback-connected to the first non-inverting input terminal,
said at least one variable resistance element comprises first to fourth variable resistance elements,
said at least one variable capacitance element comprises first to fourth variable capacitance elements,
the first variable resistance element and the first variable capacitance element are connected between the first inverting input terminal and the first non-inverting output terminal,
the second variable resistance element and the second variable capacitance element are connected between the first non-inverting input terminal and the first inverting output terminal,
the third variable resistance element and the third variable capacitance element are connected between the second inverting input terminal and the second non-inverting output terminal; and
the fourth variable resistance element and the fourth variable capacitance element are connected between the second non-inverting input terminal and the second inverting output terminal.

5. The receiving apparatus according to claim 1, further comprising an image suppressing circuit that is located between the complex filter and the orthogonal compensation circuit, or at a subsequent stage of the orthogonal compensation circuit, the image suppressing circuit performing phase shift operation, and addition or subtraction on the second in-phase signal and the second orthogonal signal so as to further suppress the image signals.

6. The receiving apparatus according to claim 5, wherein a combination of the orthogonal mixer and the image suppressing circuit has a circuit configuration of Weaver architecture or Hartley architecture.

7. The receiving apparatus according to claim 1, further comprising a phase detection circuit that detects a phase difference of the image signals between the second in-phase signal and the second orthogonal signal.

8. An image rejection method in the receiving apparatus according to claim 1, comprising:
performing at least one adjustment by the orthogonal compensation circuit so as to cancel the phase difference error and the amplitude error of the desired signals in a state in which a pseudo desired signal is input to the receiving apparatus; and
performing at least one adjustment by the controller on the complex filter so as to cancel the phase difference error and the amplitude error of the image signals in a state in which a pseudo image signal is input to the receiving apparatus.

9. The image rejection method according to claim 8, wherein said at least one adjustment by the orthogonal compensation circuit and said at least one adjustment by the controller on the complex filter are performed in the order of:
a first adjustment by the orthogonal compensation circuit,
a second adjustment by the controller on the complex filter, and
a third adjustment by the orthogonal compensation circuit to cancel an amplitude error of the desired signal generated by the second adjustment.
